(19) United States
(12) Patent Application Publication
(10) Pub. No.: US 2003/0074457 A1
(43) Pub. Date: Apr. 17, 2003

(54) Computer system with separable input device

(76) Inventor: Michael R. Kluth, Austin, TX (US)

Correspondence Address: HAMILTON & TERRILE, LLP, P.O. BOX 203518, AUSTIN, TX, 78720, US

(21) Appl. No.: 09/982,143

(22) Filed: Oct. 17, 2001

(51) Int. Cl. G06F 15/16

(52) U.S. Cl. 709/229; 709/217; 709/218; 713/202

(57) ABSTRACT

A computer system receives data from a separate input device, e.g. a personal digital assistant (PDA). The computer system is a desktop, laptop or notebook. The input device includes a memory, processor and touch screen. The input device can operate separately or when inserted into a recess in the casing of the computer system. The computer system includes two security features. A first security feature allows the input device to be used to enter data directly into the memory of the computer system. The second security feature permits synchronization of data between the computer system and the input device. The casing of the input device is configured to be compatible with the recess of the computer system casing.

### FIELD OF THE INVENTION

The present invention relates to an intelligent input device with memory for use with an associated computer system.

### DESCRIPTION OF THE RELATED ART

Computer systems are electronic information handling systems which can be designed to give independent computing power to one user or a plurality of users. A personal computer system can usually be defined as a desktop, floor standing, or portable microcomputer that includes a system processor, memory, a display monitor, an input device such as a keyboard, one or more diskette drives and a fixed disk storage device.

Consumers are interested in faster, smaller and more portable computer designs. Desktop computer systems have evolved into laptops systems. Laptop systems are portable but less convenient than smaller and lighter systems, known as notebook computers. Notebook computer systems can fit easily into a briefcase or backpack and can have approximately the same computing power as large notebooks or desktop systems. Newer notebook computer systems are light enough to be carried from home to office, or while traveling. Handheld computers evolved to replace notebooks. Handheld computers typically included a smaller version of a conventional keyboard.

Unlike desktops, laptops and handheld computers, personal digital assistants (“PDAs”) typically depend upon a touch screen as an input device. (An example of a PDA is a Palm model m125, available from Palm, Inc. 5470 Great American Pkwy, Santa Clara Calif. 95054). User interaction with the operating system is accomplished by tapping the screen of the PDA. Tapping a touch screen can launch a software application, such as an expense report or contact list. Alternatively, tapping the touch screen of a PDA can also enter data, such as the price of dinner in an expense report or a name into a contact list.

Many users maintain parallel data files in a desktop computer system and a PDA. For example, a user may maintain a contact list on the larger system when in an office but enter updated data into a PDA when away from the office. Maintaining separate databases can create errors when both databases are not updated. Thus, PDA designers have provided a “synchronization ”feature to allow updating of both databases simultaneously. For example, the contacts database in a user's notebook computer system can be synchronized with data entered into a PDA.

Synchronizing databases conventionally requires establishing a physical connection by wire or infrared data link to transfer the data between a computer system and a PDA. Thus, synchronizing databases is inconvenient for many users. What is needed is a means to facilitate exchange of data between a PDA and a computer system.

### SUMMARY OF THE INVENTION

In accordance with the present disclosure, a computer system which receives data from a separate intelligent input device such as a PPA is taught. The computer system is not limited to a desktop, laptop or notebook computer. An input device is also disclosed which can operate separately or when inserted into a recess in the casing of the computer system. The input device includes, e.g., a memory, processor and touch screen. The computer system includes at least one security feature. A first security feature allows the input device to be used to enter data directly into the memory of the computer system. The second security feature permits synchronization of data between the computer system and the input device.

In one embodiment, the casing of the computer system includes a recess to receive the input device thereby, serving as a docking port. The casing of the input device is configured to fit in with the recess of the computer system casing. When the input device is inserted into the computer system casing, data or commands, entered into the input device are simultaneously entered into the computer system.

Coupling the computer system and the input device couples the memory of the computer system and the memory of the input device. Coupling the memory of the computer system and the memory of the input device allows data entered into the input device to be stored in the memory of the computer system. In one embodiment, the input device has a touch screen. In this embodiment when the input device is coupled to the computer system data (or commands) entered on the touch screen is transmitted to the computer system.

Coupling the computer system and input device allows an exchange of data between the memory of the computer system and the memory of the input device. This exchange of data is sometimes referred to as “synchronization.” Synchronizing data allows data (such as a name or address) to be replaced in a database stored in either memory with more recent data.

The present disclosure is also directed to related software features. A computer program prevents unauthorized synchronizing of the data in a computer system and the input device. In one embodiment a user enters a security key (such as a password) to restrict synchronization of data between the devices. When the input device is coupled to the computer system the security key in the input device is compared to the security key in the computer system memory. If the security keys match, then data can be synchronized from the input device to the computer system. A computer program also controls operation of the input device with the computer system. This additional security feature uses a password to restrict an input device from being used with computer systems other than the computer system (or systems) that the user has selected. If the security keys match then the input device can be used to enter data (or commands) directly into the computer system.

The input device transmits data to (and receive data from) the computer system over a communication network such as the Internet. The input device also transmits data to (and receives data from) a wireless communication network. The device also receives data from other wireless sources such as an FM radio station, AM radio station or pager. The input device can include other features, such as an MP-3 player, point stick or pager. In one embodiment the input device is a PDA.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1A shows a computer system with an input device inserted. FIG. 1B shows a computer system with the input device removed. FIG. 1C represents the touch screen of the device when the device is not installed in a computer system. FIG. 1D shows the touch pad when it is installed in a computer system.

FIG. 2 shows a flow diagram of logical steps of docking the input device in the computer system.

FIG. 3 shows a flow diagram which identifies logical steps in the process of data synchronization.

FIG. 4 shows a flow diagram which identifies logical steps in the process of removing the input device from the computer system.

FIG. 5 is a block diagram of one configuration of the input device.

FIG. 6 is a block diagram of an exemplary computer system.

The disclosure contains, by necessity, simplifications, generalizations and omissions of detail; consequently, those skilled in the art will appreciate that the disclosure is illustrative only and is not intended in any way to be limiting.

### DETAILED DESCRIPTION

The following sets forth a detailed description of a mode for carrying out the invention. The description is intended to be illustrative of the invention and should not be taken to be limiting. A method is taught for exchanging data between an input device and a computer system. The disclosure also is of an input device into which a user can enter data. The disclosure further is of software to facilitate exchange of data between a device and a computer system. The disclosure is not limited to a device, a method or software. For example, a configuration is also taught that allows the input device to be inserted into a laptop or other computer system. In an embodiment the input device is similar, or equivalent to, a PDA.

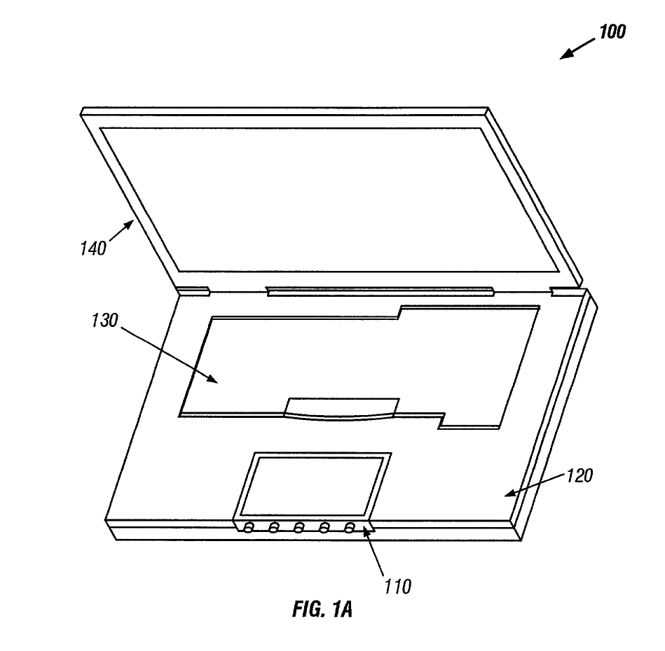

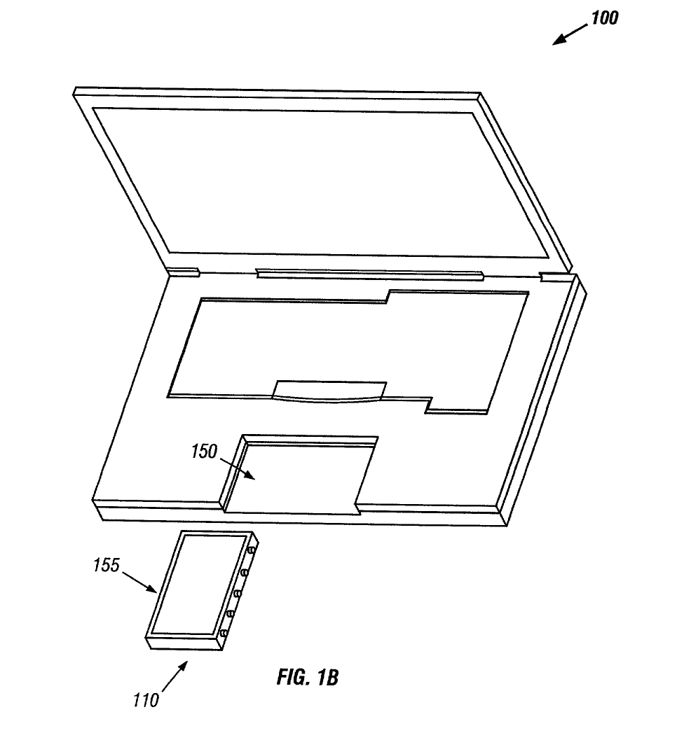

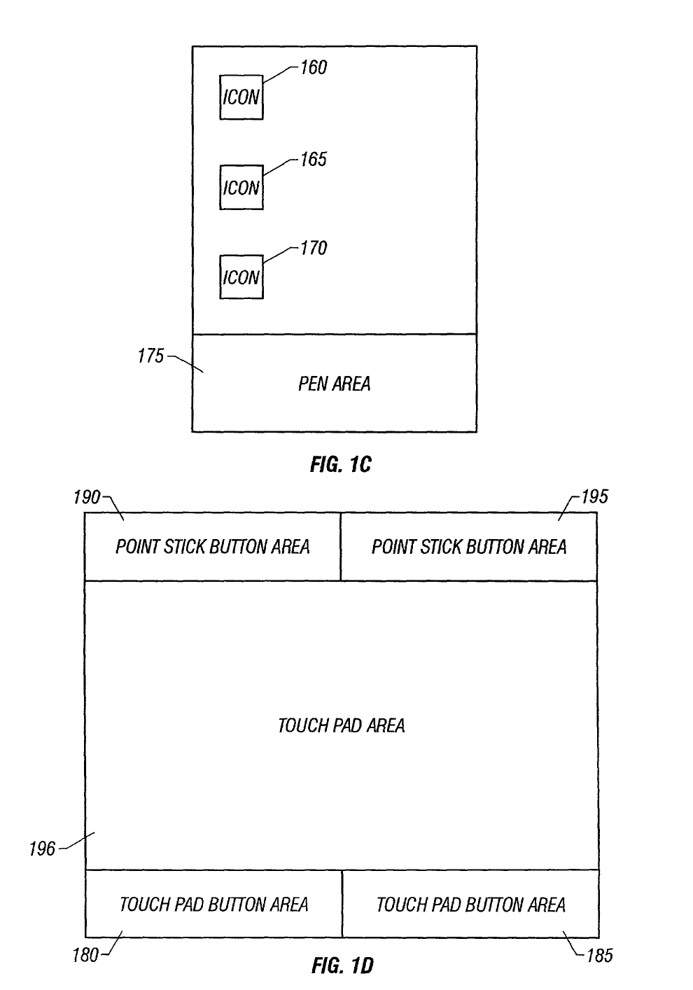

FIG. 1A shows a mostly conventional computer system 100 with a mostly conventional input device 110. As shown in FIG. 1A, computer system 100 is a laptop or notebook system. FIG. 1A is not limiting; computer system 100 can also be a desktop computer system or other computing device. Input device 110 has in one embodiment a touch screen such as commonly found in a PDA. FIG. 1A shows input device 110 mounted within recess 150 (shown in FIG. 1B) in the casing of otherwise conventional computer system 100. The configuration shown in FIG. 1A allows input device 110 to be inserted in computer system 100 on surface 120 adjacent to keyboard 130. As shown in FIG. 1A, input device 110 is inserted into computer system 100 adjacent the keyboard. In the configuration shown, surface 120 of computer system 100 is conventionally approximately level with the surface of the keyboard, allowing the computer system lid 140 to close.

FIG. 1B shows input device 110 separated from computer system 100. Recess 150 is configured to allow device 110 to be inserted or removed by a user. Inserting device 110 into computer system 110 requires a clearance between surfaces so that a user can easily insert the device. In an embodiment, device 110 is inserted and removed from recess 150 using a lever-type device, e.g., the stylus conventionally provided with a PDA. In another embodiment, no external tools or other apparatus is needed to couple the input device to the computer system. Although a recess is shown in FIG. 1B, other configurations which couple device 110 to computer system 100 are within the spirit of the disclosure and scope of the invention. For example, another configuration (not shown) to couple device 110 to computer system 100 would allow device 110 to be inserted partially, or completely, into computer system 100, similar to inserting a key into a lock.

In FIG. 1B, computer system 100 and device 110 can operate separately. More specifically, computer system 100 operates as a conventional computer system and performs word processing, communication, data storage or other conventional functions. Device 110 operates separately as a data input device. In one embodiment, device 110 performs similar, or equivalent functions to a PDA.

Synchronizing data is conventionally necessary when data is entered in input device 110 then revised data is entered into computer system 100. (In this context “synchronizing ”means “making the same.”) Conversely, synchronizing data can also be necessary when data is entered into computer system 100 then revised data is entered into device 110. For example, a user may enter a contact such as “Mr. White” as President of Company A into the computer system (such as computer system 100 shown in FIG. 1A) in his office. Later in a meeting not in his office the use may learn that Mr. White is no longer President of Company A. Without immediate access to computer system 100, the user may enter the new name of the President of Company A into a device, such as device 110 shown in FIG. 1A. Later, the user may synchronize the contacts database between device 110 and the computer system. Synchronizing data requires connecting computer system 100 and input device 110. The connection can be established by inserting input device 110 into computer system 100 as shown in FIG. 1A or by other means as discussed further below.

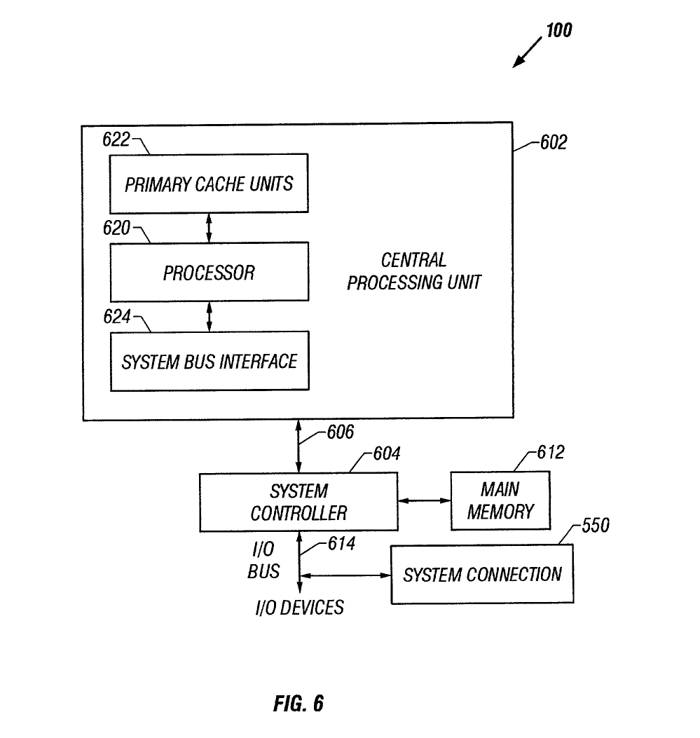

In an embodiment, input device 110 can slide on rails into computer system 100. In this embodiment the rails extend horizontally when computer system is resting on a horizontal desk or table. When rails are used, input device 110 is inserted in a horizontal motion. The horizontal motion of inserting device 110 into computer system 100 (on rails or other suitable supports) also electronically couples the memory of device 110 to the memory of computer system 100 as discussed further below (refer to FIG. 6).

In another embodiment a latch can be used instead of rails for inserting and holding input device 110 into computer system 100. A magnetic latch is suitable for holding input device 110 in place in computer system 100. (A slip fit is possible but not preferred due to the potential of plastic surfaces to deform.) A typical dimension of device 110 is four inches by six inches by one inch (10 cm by 15 cm by 2.5 cm). However, any dimension suitable for inserting and removing a device from a computer system is also suitable.

Typically, an electrical connection is established by mating conventional Universal Serial Bus connectors (also referred to as USB connectors) installed on, respectively, device 110 and computer system 100 or by using other standard or proprietary interfaces. For example, USB connector 2.0 can be used. In another embodiment an IEEE standard 1394 interface (also referred to as “Firewire”) is used in lieu of the USB connector.

FIG. 1C shows the touch screen of the input device in an operating configuration when the input device is not installed in the computer system. As shown in FIG. 1C, icons 160, 165 and 170 conventionally represent software applications operable when the device is in a stand alone configuration. For example, icon 160 represents a word processing application. In another example icon 165 is a graphics application. And in another example icon 170 represents a task scheduler. Still referring to FIG. 1C, pen area 175 represents an area which accepts input data from a stylus or pen. Pen area 175 can also accept input from a user's hand, finger or other source of pressure.

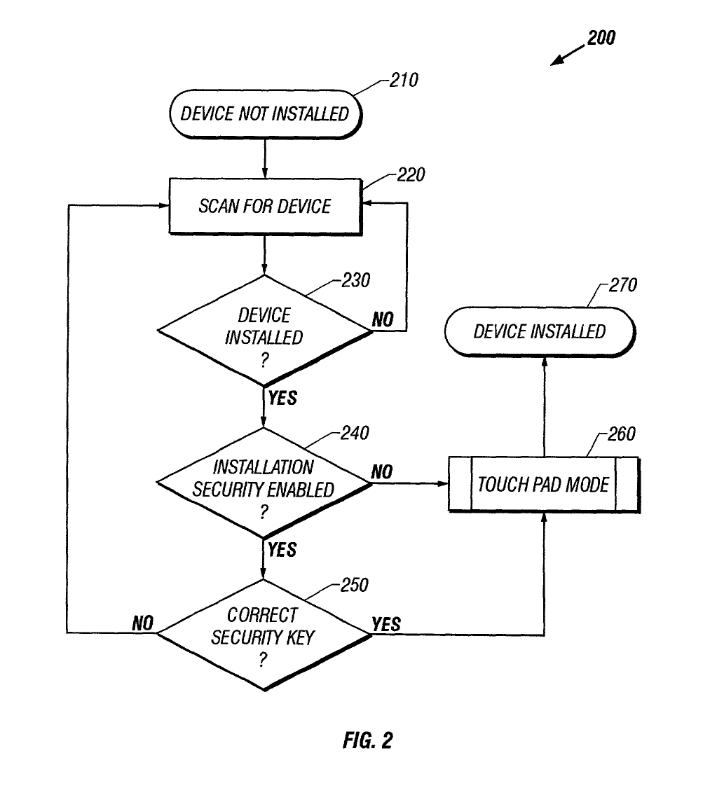

FIG. 1D shows a configuration of the input device (previously shown in FIG. 1C) when the input device is installed in the computer system. Specifically, FIG. 1D shows the operating configuration of the touch screen. Button area 180 (also referred to as left touch pad button area 180) and button area 185 (also referred to as right touch pad button area 185) represent logical buttons recreated within the touch screen to simulate functions of buttons normally found on a mouse. Button area 190 (also referred to as left point stick button area 190) and button area 195 (also referred to as right point stick button area 195) represent logical buttons recreated within the touch screen to simulate functions of buttons normally used in conjunction with a point stick. (A point stick is used by some users as a substitute for a mouse.) As discussed further below (refer to FIG. 2), a command from computer system 100 received by device 110 causes the reconfiguration of the touch screen from the configuration shown in FIG. 1C to the configuration shown in FIG. 1D. The configuration shown in FIG. 1C is a configuration for use as a conventional PDA. In comparison, the configuration shown in FIG. 1C is for use only as in input device to a computer system.

FIG. 2 shows a flow diagram (200) of logical steps of docking the input device in the accommodating recess (port) computer system. When device 110 (shown in FIG. 1A) is inserted into computer system 100 (also shown in FIG. 1A) synchronization can occur. (If the computer system is not switched on, synchronization occurs when the computer system is switched on and the operating system begins to operate.) Process 200 begins from step 210, when input device 110 is not inserted (hereinafter “installed ”or simply “docked”) in computer system 100. From step 210 the method continues to scan for device, step 220. Step 220 provides information to the next step, device installed 230. The information provided by step 220 can be in the form of a signal received from a sensor, a switch position that changes when a device is installed in the computer system, or another suitable signal. For example, step 220 can detect a voltage which is grounded when the device is installed. From scan for device 220 the method proceeds to device installed 230. Device installed 230 is a decision which determines if a device is installed. If a device is not installed the method returns to scan for device 220. If a device is installed then the method proceeds to installation security enabled at 240. Installation security enabled 240 is also a decision. If installation security is not enabled the method proceeds from step 240 to touch pad mode, 260. Touch pad mode 260 allows the input device to operate only touch pad mode only. More specifically, when operating in touch pad mode, data entered on the touch screen is communicated directly to the computer system without being first stored in the memory of the device and functions of the input device which operate when the device is not coupled to the computer system are disabled. From step 260 the method proceeds to device installed, 270.

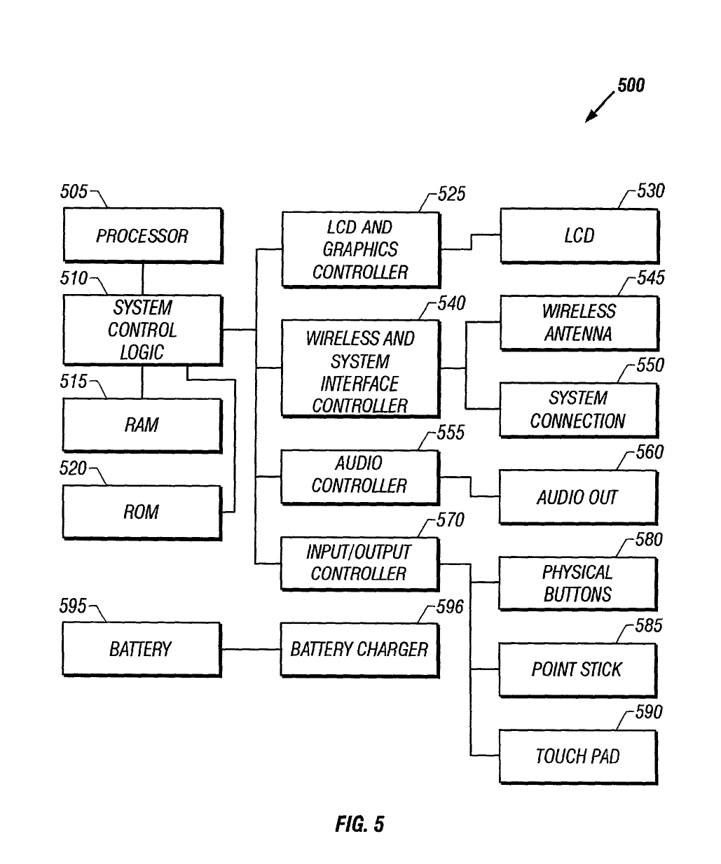

As discussed above (refer to FIG. 1C and FIG. 1D) the operating configuration of the touch screen changes when device 110 is coupled to computer system 100. Referring to FIG. 2, touch pad mode 260 represents a command from computer system 100 to device 110. For example, the command embodied in step 260 can be a software level command, status line or system management processor command. Upon receipt of the signal represented by step 260 the device (device 110) executes embedded commands to change operating configuration of the touch screen operation from the configuration shown in FIG. 1C to touch pad configuration (as shown previously in FIG. 1D). In one embodiment the embedded commands (as shown in FIG. 2) are stored in ROM memory of device 110 (refer to FIG. 5, ROM 520).

Still referring to FIG. 2, step 240 is a decision. A negative condition has previously been discussed (refer to preceding paragraph). Continuing again from step 240, if security is enabled then the method proceeds to step 250. Step 250 is a decision based on whether device 110 has a correct security key. (The function of the security key is described below in greater detail.) If the device does not have the correct security key, the method proceeds to step 220 (see above). If the device has the correct security key (similar in function and characteristics to a password) the method proceeds to touch pad mode at 260.

Step 250 compares two security keys previously entered. (The user has previously entered a security key into the input device and a security key into the computer system.) If the security keys do not correspond then device 110 will not operate compatibly with computer system 100. If the security keys do not match then data from computer system 100 will not synchronize with data from device 110. Specifically, the synchronization function is disabled. Unless the security keys match a user cannot operate device 110 as an input device to computer system 100.

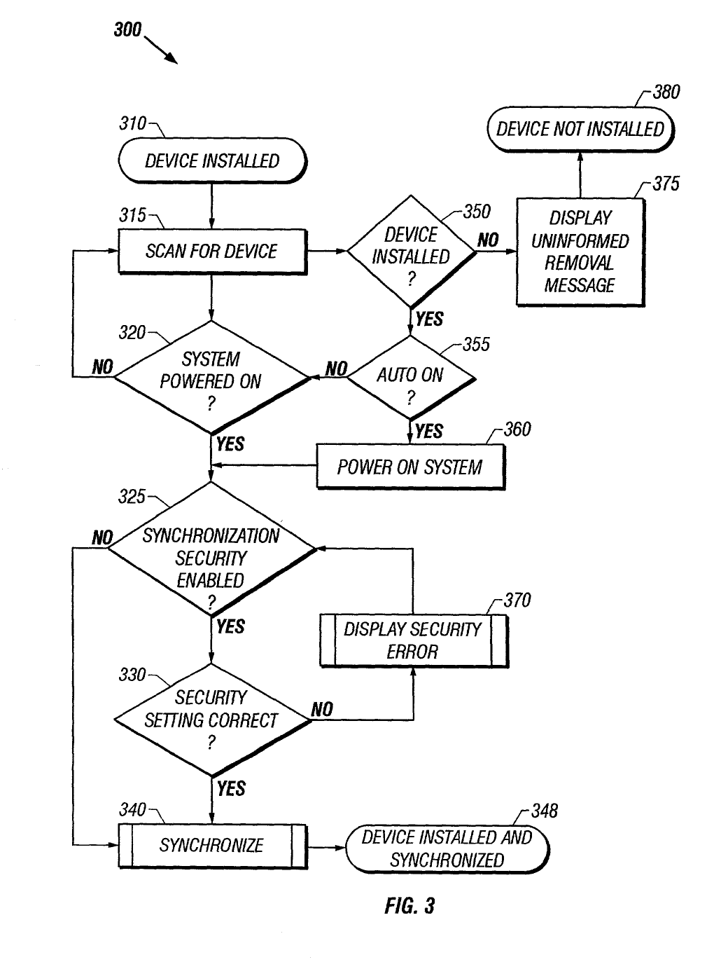

FIG. 3 shows a flow diagram 300 which identifies logical steps in the process of synchronizing data stored in device 110 with computer system 100. Flow diagram 300 begins with device installed, step 310. From step 310 the method proceeds to scan for device at 315. Scan for device 315 is a function which provides information to the next logical step, device installed 350. The information provided by step 315 is in the form of a signal received from a sensor, a switch position that changes when a device is installed in the computer system, or another suitable form of data. Device installed 350 is a decision with two branches. If a device is installed the method proceeds to auto on, step 355. Auto on 355 is a function which can be stored in firmware. When the function (auto on 355) is not enabled the method proceeds to system powered on, step 320. A user can chose to select or enable the function. From auto on (step 355) the method can proceed to system powered on (step 320) if the auto on function is not enabled or to power on system 360 (if the auto on function is not enabled by a user). (From step 360 the method proceeds to a point in the logical method subsequent to system powered on, step 320.)

System powered on 320 is also a decision. If the system has no power from an external source (such as a battery or 110 volt external power supply) then the method returns to scan for device at 315. But if the auto on function is not enabled (as previously discussed) and the system has an external power supply (or battery power supply) as represented by the affirmative branch of decision 320, the method proceeds to synchronization security enabled at 325.

Synchronization security is a second level of security before data from device 110 is synchronized (or exchanged with) computer system 100. Referring briefly to FIG. 2, the first level of security has previously been discussed, see specifically step 240. Now referring to FIG. 3, a second level of security is also present. Satisfying the first level of security is necessary to enable device 110 to operate as an input device for computer system 100. Satisfying the second level of security is necessary to enable synchronization (also called exchange) of data between device 110 and computer system 100. In an embodiment a user enters a second set of passwords into computer system 100 and device 110. When device 110 is coupled to computer system 100 a software feature compares the second set of passwords. If the password match the second level of security is satisfied and data can be synchronized. If the first level of security is satisfied, but the second level of security is not satisfied, then device 110 will operate as an input device to computer system 100 but data will not be synchronized.

Still referring to FIG. 3, synchronization security enabled 325 is an option selected by the user. The feature can be stored in firmware in the computer system BIOS. From step 325, if synchronization security is not enabled the method proceeds to synchronize at 340. Synchronize 340 replaces outdated data from the memory of the computer system with since-revised data in the memory of the device. In one embodiment, synchronize 340 also replaces outdated data from the memory of the device with since-revised data from the memory of the computer system. From synchronize 340 the method proceeds to device installed and synchronized at 345.

Returning to step 325, if synchronization security is enabled the method proceeds to security setting correct at 330. Security setting correct 330 is also a decision. Security setting correct compares a second set of passwords entered by a user. If the second set of passwords agree then the method proceeds to synchronize, 340. If the second set of passwords agree, then the method proceeds to display security error, 370. Display security error 370 displays on a screen (or other display visible to a user) a message informing the user that the second level of security is not satisfied.

Still referring to FIG. 3, refer to again to device installed, step 350. As previously noted, device installed 350 is a decision. (The positive branch of this decision has previously been discussed.) From device installed 350 the method can proceed to display uninformed removal message, 375 (the negative branch of the decision). Display uninformed removal message 375 is a step which displays a message to a user. The message informs the user that an attempt has been made to remove the device without reconfiguring the computer operating system. From step 375 the method proceeds to device not installed at 380.

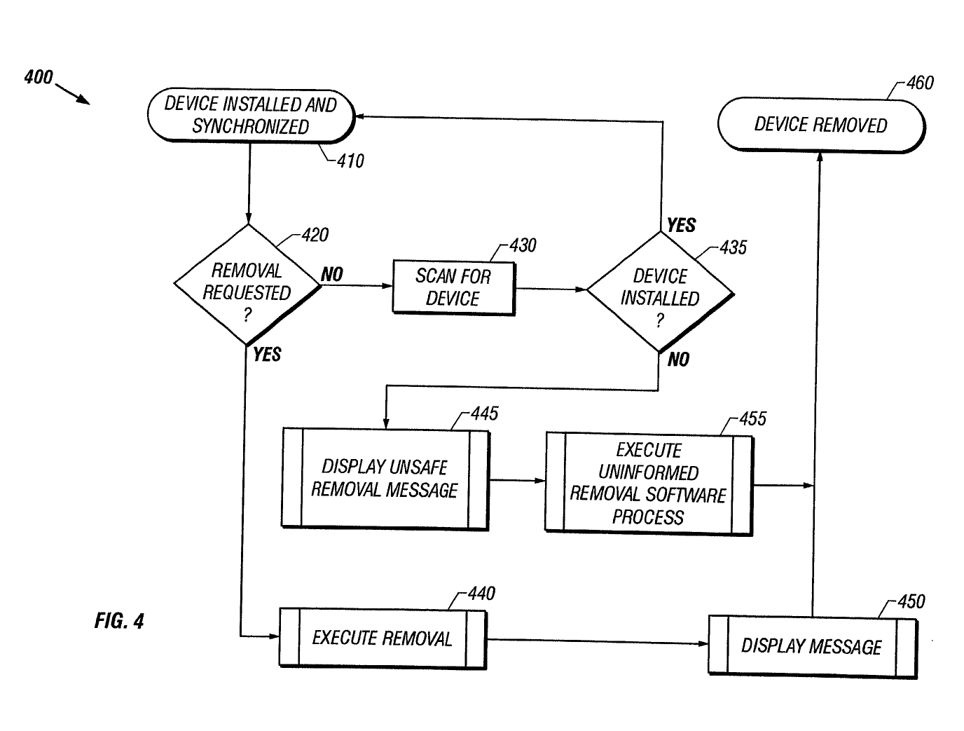

FIG. 4 shows a flow diagram 400 which identifies logical steps in the process of removing the input device from the computer system. From device installed and synchronized at step 410 the method proceeds to removal requested, step 420. Step 420 represents a command entered by a user to the operating system to facilitate removal of device 110 from computer system 100. A user enters the command either by keyboard or by other means. For example, removal requested 420 can be a command entered by a user by means of a button on the device or on the computer system.

If the user requests removal of the input device (as discussed in the preceding paragraph) the method proceeds to execute removal at 440. Execute removal 440 generates commands to the computer system (and if appropriate to the input device) enabling other means (such as a conventional keyboard) for entering data into computer system 100. Execute removal 440 also configures device 110 to accept data and commands entered on the touch screen of the device. (Previously, data and commands entered into device 110 had been communicated to computer system 100.) Execute removal 440 provides information and commands from the operating system to logically isolate device 110 from computer system 100. For example, execute removal 440 can represent commands generated by the operating system to close certain files associated with the computer system and additional files associated with the device. Furthermore, execute removal 440 also provides a command to the device to reconfigure the touch screen from the configuration shown in FIG. 1D to the configuration shown in FIG. 1C. In another embodiment, the operating system can also disconnect the power supply from computer system 100 to device 110. From execute removal 440 the method proceeds to display message, 450. Display message 450 informs a user that the user can remove the device from the computer system without compromising integrity of data in the device or in the computer system. From display message 450 the method proceeds to device removed, 460.

Still referring to FIG. 4, return to step 420. From step 420, if the user has not requested removal of the device, the method can proceed to scan for device at 430. (Scan for device 430 can be similar in function to step 220 in FIG. 2.) Scan for device 430 provides data to device installed, 435. Based on the data received from step 430, if device installed 435 determines that an input device is installed but removal has not been requested (refer to step 420) then the method returns to step 410. However, if device installed determines that an input device is not installed and no removal has been requested (refer to step 420) then the process continues to step 445 which generates a message and displays a message to the user indicating that it is unsafe to remove the input device from the computer system. (Referring briefly to removal requested 420 note that the user has not requested removal of the input device.)

From display unsafe removal message 445 the method proceeds to execute uninformed removal software process, step 455. (In one embodiment, when installation security is set (refer to FIG. 2, installation security 240) then the computer system shuts down, or stops operating.) From step 455 the method can proceed to step 460 which permits the computer system to operate in a configuration without device 110 installed.

The method disclosed is not restricted to a specific software, software language or software architecture. Each of the steps of the method disclosed may be performed by a module (e.g., a software module) or a portion of a module executing on computer system 100. The method may be embodied in a machine-readable and/or computer-readable medium for configuring a computer system and/or an input device to execute the method. Thus, the software may be stored within and/or transmitted to a computer system memory to configure the computer system to perform the functions.

The software discussed herein which performs the described steps may conventionally include script, batch or other executable files, or combinations and/or portions of such files. The software modules may include software code as well as data and may be encoded on computer-readable media. Furthermore, those skilled in the art will recognize that the operations described herein are for illustration only. Operations may be combined or the functionality of the operations may be distributed in additional operations in accordance with the invention.

FIG. 5 is a block diagram of one configuration of the mostly conventional input device, such as device 110 (previously shown in FIG. 1A). As shown in FIG. 5, processor 505 is operably coupled to system control logic, 510. Processor 505 controls operation of the system control logic 510 which is operably coupled to RAM 515. RAM (also conventionally referred to as “random access memory”) 515 stores and communicates data to and from system control logic 510. ROM (also conventionally referred to as “read only ”memory) 520 can receive data from or send data to system control logic, 510. In one embodiment, ROM stores the security key.

Still referring to FIG. 5, system control logic 510 is operably coupled to LCD and graphics controller 525, wireless and system interface controller 540, audio controller 555, and input/output controller 570. LCD and graphics controller 525 is operably coupled to, and controls the operation of LCD 530. LCD and graphics controller 525 can generate characters and graphics on LCD 530. When the device is not docked, LCD (sometimes referred to as liquid crystal display) 530 is an output device converting data received from LCD and graphics controller 525 to images for viewing by a user.

Wireless system and interface controller 540 is operably connected to system connection 550. System connection 550 facilitates sending and receiving information to a separate computer system, such as computer system 100 (previously shown in FIG. 1A. System connection 550 is a direct physical connection to computer system 100 (as shown in FIG. 1B) or other means, such as a wireless connection. Alternately, system connection 550 is a wireless connection. For example the wireless connection may be based on the IEEE 802.11 industry standard promulgated by the Institute of Electrical and Electronic Engineers. Alternatively, the wireless connection may utilize a de-facto industry standard such as Bluetooth promulgated by Promoter Members of Bluetooth SIG, Inc. (“Bluetooth SIG”).

Wireless system and interface controller 540 sends signals to, and receives signals from, antenna 545. Antenna 545 facilitates receiving and receiving information (such as email) without cable or other direct connection to a network. Antenna 545 is also suitable to receive AM radio signals, FM radio signals or other signals.

Still referring to FIG. 5, system control logic 510 is operably coupled to audio controller 555. Audio controller 555 controls an audio signal such as MP3, AM radio or FM radio. Audio controller 555 is operably coupled to audio out 560. Audio out 560 can be a conventional speaker (or conventional headphone) capable of converting an audio signal from an electric signal into an audible form.

System control logic 510 is also operably coupled to input/output control 570. Input/output control 570 receives information from other components such as physical button 580, point stick 585 and touch pad 590 (sometimes referred to as touch screen). Touch pad 590 can be of a type available from Panasonic, part number TM41PDD234. Touch pad 590 is typically located on top of LCD 530. Touch pad 590 can enable a pen, light, pressure (touch) or other user interface. Physical button 580 is used to turn on the device. The device can also incorporate other features; for example cpu 505 can control a point stick (not shown). A point stick is an input mechanism operated by a user by moving one end of a flexible stalk with the tip of a finger. (A point stick can be of a type available from Synaptics of San Jose, Calif. part number TM41PDD234).

Still referring to FIG. 5, battery 595 and battery charger 596 are shown. Battery 595 provides power to the device when the device is not docked in the computer system. Battery charger 596 is an optional device. Battery charger 596 permits the device to be recharged from an alternating current (“a/c”) power source, such as a conventional wall outlet.

FIG. 6 is a block diagram of a mostly conventional and exemplary computer system, such as computer system 100 previously shown in FIG. 1A. Thus, FIG. 6 is intended to be illustrative of a computer system and is not limiting. Referring to FIG. 6, computer system 100 includes central processing unit 602. The central processing unit 602 is coupled to system controller 604 via system bus 606 and is coupled to secondary cache unit 608, the secondary cache unit being coupled to central processing unit 602 via secondary cache bus 610. The system controller is coupled main memory 612 and is coupled to I/O devices through I/O bus 614. Central processing unit 602 includes processor 620, the processor 620 being coupled primary cache 622 and includes system bus interface 624, the system bus interface 624 being coupled to the system bus 606. As shown in FIG. 6, I/O bus 614 provides a possible connection to system connection 550 (previously shown in FIG. 5). Thus, data can be exchanged between device 110 and computer system 100 though a bus such as I/O bus 614. One skilled in the art will also recognize that other connections allowing exchange of data between device 110 and computer system 100 are possible.

One skilled in the art will also recognize that the foregoing components and devices are used as examples for conceptual clarity and that various configuration modifications are common. For example, processor 620 is used as an exemplar of any general processing unit, including but not limited to multiprocessor. As used herein, the specific exemplars set forth in FIG. 6 are intended to be representative of their more general classes. As before, the use of any specific exemplar herein is also intended to be representative of its class, and the non-inclusion of such specific devices in the foregoing list should not be taken as indicating that limitation is desired.

One skilled in the art will recognize that the foregoing components and devices are used as examples for conceptual clarity and that various configuration modifications are common. In addition, it is appreciated that operations discussed herein may include, for example, directly entered commands by a computer system user, steps executed by application specific hardware modules, steps executed by software modules, or combinations thereof.

The operations described above and software therefor may be executed on a computer system configured to execute the operations of the method and/or may be executed from computer-readable media. The method may be embodied in a machine-readable and/or computer-readable medium for configuring a computer system to execute the method. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims.

What is claimed is:

1. A computer system capable of communicating with an input device having a memory, the computer system comprising:
a processor;
a memory operably coupled to the processor, and
a computer program stored in a memory associated with the processor, comprising:
a set of instructions configured to provide a first decision, wherein the first decision permits data stored in the memory of the input device to be transmitted to the memory of the computer system; and
a set of instructions configured to provide a second decision, wherein the second decision permits synchronization of data between the memory of a computer system and a memory of the input device.

2. The computer system of claim 1, further comprising:
a casing housing the processor and memory and defining a recess, the recess configured to receive the input device.

3. The computer system of claim 1, further comprising:
a docking station in a housing of the computer system, the docking station defining a recess, the recess configured to receive the input device.

4. A computer program product, comprising:
a set of instructions configured to provide a first decision, wherein the first decision permits data entered into an input device to be transmitted to a memory of a computer system if a first security condition is satisfied; and
a set of instructions configured to provide a second decision, wherein the second decision permits synchronization of data between the memory of a computer system and a memory of the input device if a second security condition is satisfied.

5. The computer program product of claim 4, further comprising:
a set of instructions configured to display a message if the first decision is not satisfied.

6. The computer program product of claim 4, further comprising:
a set of instructions configured to display to a user a message if the second decision is not satisfied.

7. The computer program product of claim 4, further comprising:
a set of instructions configured to synchronize data stored in the memory of the computer system with data stored in the memory of the input device.

8. The computer program product of claim 4, further comprising:
a set of instructions configured to display a message if a user attempts to disconnect the input device from the computer system without satisfying a predetermined condition.

9. A method of operating a computer system with an associated input device, comprising;
connecting the input device to the computer system by inserting a housing of the input device in a housing of the computer system;
storing a first password and a second password into a memory of the computer system; and
storing data from the computer system into the memory of an input device.

10. The method of claim 9, wherein the input device is a personal digital assistant.

11. The method of operating a computer system of claim 9, wherein inserting the input device into the computer system housing operably couples the memory of the computer system to the memory of the input device.

12. The method claim 11, further comprising:
initiating synchronization of data stored in the memory of the computer system and data stored in the memory of the input device.

13. The method of claim 9, wherein the input device further comprises a touch screen.

14. The method of claim 13, further comprising:
entering a command onto the touch screen of the input device, wherein the command is communicated from the touch screen of the input device to the computer system.

15. A system for entering data into a computer system, comprising:
means to input data into the computer system,
means to process data entered into the computer system;
means to store data entered into the computer system, the means to store data operably coupled to the means to process data; and
means to operably couple the means of storing data to a means of storing data in an input device when the input device is inserted into the computer system.

16. A system for entering data into the computer system of claim 15, further comprising:
means to store digital audio signals.

17. A system for entering data into the computer system of claim 15, further comprising:
means to receive an amplitude modulated radio signal.

18. A system for entering data into the computer system of claim 15, further comprising:
means to receive an frequency modulated radio signal.

19. A system for entering data into the computer system of claim 15, further comprising:
means to enter data into the input device by depressing a display surface, the display surface operably coupled to the input device.

20. A system for entering data into the computer system of claim 15, further comprising:
means to synchronize data entered into the input device with data entered in the computer system; and
means to prevent an unauthorized synchronization of data entered into the input device with data stored in the memory of the computer system.

21. An input device, comprising:
a processor;
a memory operably coupled to the processor; and
a casing, the casing housing the processor and the memory, the external surface of the casing of the input device configured to be inserted into a recess defined in a computer system casing.

22. The device of claim 21, further comprising:
a computer program stored in the memory, comprising:
a set of instructions configured to provide a first decision, wherein the first decision permits data entered into a the input device to be transmitted the memory of the computer system; and
a set of instructions configured to provide a second decision, wherein the second decision permits synchronization of data between the memory of a computer system and a memory of the input device.

23. The input device of claim 22, wherein the input device further comprises:
an amplitude modulated radio receiver.

24. The input device of claim 21, wherein the input device further comprises:
a frequency modulated radio receiver.

25. The input device of claim 21, wherein the input device further comprises:
a digital pager.

26. The input device of claim 21, wherein the input device further comprises:
a touch screen.

27. The input device of claim 21, wherein the input device further comprises:
a point stick.

28. The input device as recited in claim 21, wherein the input device is a personal digital assistant.

29. The input device of claim 21, wherein the memory of the input device is operably configured to store data in an audio format.

30. The input device of claim 21, wherein inserting the input device into the recess of the computer system operably couples the memory of the computer system to the memory of the input device.

31. The input device of claim 21, wherein the input device receives data from the computer system over the Internet.

32. The device for a computer system as recited in claim 21, wherein the device receives data from the computer system over a wireless network.

33. A system for synchronizing data, comprising:
a first means to process data;
a first means to store data, the first means to store data operably coupled to the first means to process data;
a second means to process data;
a second means to store data, the second means to store data operably coupled to the second means to process data; and
a means to operably couple the memory of the computer system to a memory of the input device when the input device is inserted into the computer system.

34. The system of claim 33, further comprising:
means to store a first password;
means to store a second password; and
means to compare the first password to the second password and permit synchronization of data if the first password and the second password match.

35. The system of claim 33, further comprising:
means to synchronize data stored in the computer system with data stored in the input device.

36. The system of claim 33, further comprising:
means to receive data from the input device over the Internet.

37. The system of claim 33, further comprising:
means to receive data from the input device over a wireless network.
